(19) United States
(12) Patent Application Publication
(10) Pub. No.: US 2018/0093201 A1
(43) Pub. Date: Apr. 5, 2018

(54) MODULAR-TYPE ANALYSIS SYSTEM

(71) Applicant: Shimadzu Corporation, Kyoto (JP)

(72) Inventors: Yusuke YOKOI, Kyoto (JP); Kazuya TAKAHASHI, Moriyama (JP)

(21) Appl. No.: 15/563,767

(22) PCT Filed: Apr. 3, 2015
(86) PCT No.: PCT/JP2015/060585

§ 371 Date: Oct. 2, 2017

(51) Int. Cl. B01D 15/22; G01N 30/22; G01N 30/60; G01N 35/00

(52) U.S. Cl. CPC B01D 15/22; G01N 30/22; G01N 2030/522; G01N 30/6026; G01N 35/00; G01N 30/6039

(57) ABSTRACT

In the non-volatile storage unit (341) of the local control unit (34) of each unit (3 to 6) configuring an LC system, periodic inspection information, such as the installation date and the next inspection scheduled date, is stored at an appropriate time. When an analysis is carried out, in the system control unit (2) which controls each unit, a periodic inspection notification processing unit (211) collects periodic inspection information from each unit (3 to 7) upon power on or start up, compares the next inspection scheduled date with the current time by the real-time clock (212), and determines a unit for which a periodic inspection notification is required. If there is a unit that requires a periodic inspection notification, a notification request is sent to the unit, and the local control unit (34) of the unit outputs an indication prompting periodic inspection to the display unit (35). As a result, even if the installation times are different for each unit and even if each unit does not have a real-time clock, it is possible to notify a user when a predetermined age of service has passed from the installation time of a given unit.

### TECHNICAL FIELD

The present invention relates to a modular-type analysis system capable of executing a predetermined analysis by combining a plurality of units having different functions.

### BACKGROUND ART

In analytical instruments, in addition to an integrated type device in which functions necessary for an analysis are incorporated in one housing, there also exists a modular-type device which configures a system by combining a plurality of units having different functions. For example, in a liquid chromatograph disclosed in a non-Patent Document 1, units having various functions, such as a liquid supply unit, an autosampler (auto injector) unit, a column oven unit, a detector unit of various detection methods, a fraction collector unit, etc., or unit in which basic functions are the same but additional functions are different are provided. Further, a system control unit for comprehensively controlling each of those units is also provided. By suitably combining these units depending on the purpose, a user can construct a liquid chromatograph (LC) system with good cost performance that can perform appropriate measurement without adding unnecessary functions.

By the way, in such an analytical instrument, many precision mechanical parts and electric circuit parts are used. These parts deteriorate as the apparatus is used, and even in cases where the apparatus has not been used, the deterioration gradually progresses, which in turn sometimes becomes impossible to fulfill desired functions or results in breakage or damage. Therefore, in order to maintain the performance of the analytical instrument and ensure safety, periodic inspection and maintenance are indispensable regardless of the actual operating time of the equipment. For this reason, it is desirable that a user of an analytical instrument performs periodic inspection and maintenance (normally, the user asks inspection or maintenance to the equipment manufacturer, etc.) after a specified period (e.g., 10 years) has elapsed from the time when a certain analytical instrument is newly purchased and installed and repeatedly performs periodic inspection and maintenance every time the specified year and month has passed after the previous periodic inspection.

Thus, in order to ensure such periodic inspection, a user is required to manage the elapsed years and months after the installation time of the analytical instrument, but such management is troublesome and tends to be neglected. Therefore, in order to solve the troublesome of managing the age of service by a user, it is conceivable to have a function to record the installation date, etc., in the built-in memory of the analytical instrument and notify the necessity of the periodic inspection when a given year and month has elapsed after the installation date, etc. In the aforementioned modular-type analysis device, however, the management of the age of service is considerably cumbersome for the following reasons.

(1) In a modular-type analysis device, it is common to rearrange its units depending on the purpose of the analysis or perform replacement of only some of units. Therefore, since the purchase times and the installation times of a plurality of units constituting a system often differ, the management of the age of service as the entire system is less meaningless, and therefore it is necessary to manage the elapsed years from the installation time, etc., for each unit.

(2) The automatic management of the actual operating time in each unit can be realized by using a timer that can measure the elapsed time in each unit as disclosed in, for example, Patent Document 1. On the other hand, in order to automatically carry out the management of the age of service including the aforementioned non-operating period, a real-time clock is required. For example, however, in each unit constituting the aforementioned LC system, the unit only operates in response to a control signal sent from the system control unit. For this reason, the current time is unnecessary, and therefore, in general, no real-time clock is mounted in each unit. Therefore, the management of the age of service cannot be performed in each unit.

### PRIOR ART

### Patent Document

Patent Document 1: Japanese Unexamined Patent Application Publication No. 11-108909

### Non-Patent Document

Non-Patent document 1: “Liquid chromatograph (HPLC)”, [online], Shimadzu Corporation, [Searched on Mar. 20, 2015], Internet <URL: http://www.an.shimadzu.co.jp/hplc/hplc.htm>

### SUMMARY OF THE INVENTION

### Problems to be Solved by the Invention

The present invention was made in view of the aforementioned problems, and an object of the present invention is to provide a modular-type analysis system composed of a plurality of units and capable of reliably notifying a user of necessity of periodic inspection when the age of service of each unit has passed a prescribed number of years even if an installation time of each unit is different or each unit does not have a real-time clock.

### Means for Solving the Problems

The present invention made to solve the aforementioned problems is directed to a modular-type analysis system constituting a system for performing an analysis by combining a plurality of units each having an independent housing, the system including an integrated control unit for controlling operations of the plurality of units so as to perform the analysis, and the integrated control unit being provided independently in an independent unit different from the plurality of units or provided in one of the plurality of units. The modular-type analysis includes:
a) a date information storage unit provided in each of the plurality of units to store at least one of reference date information which becomes a reference for counting year and month at which periodic inspection of each of the plurality of units is to be carried out and information on a next periodic inspection notification scheduled date;
b) a periodic inspection processing unit included in the integrated control unit and configured to collect information stored in the date information storage unit in each unit, judge whether or not a periodic inspection notification date has reached for each unit based on the collected information, and send, when there is a unit that has reached the periodic inspection notification date, a periodic inspection notification request to the unit; and
c) a display processing unit provided in each of the plurality of units and configured to display information prompting implementation of periodic inspection in response to the periodic inspection notification request from the periodic inspection processing unit.

In the modular-type analysis system according to the present invention, the integrated control unit may be an independent unit or may be built in any one of the plurality of units. In either configuration, the basic processing operation is the same.

Further, the aforementioned “reference date information which becomes a reference for counting years and months at which periodic inspection of each of the plurality of units is to be carried out” denotes, for example, the date at which the unit was installed, the date at which the periodic inspection was performed most recently, or the like.

In the modular-type analysis system according to the present invention, the date information storage unit is provided in each unit constituting the system, and reference date information which becomes a reference for counting the year and month at which periodic inspection of the unit is performed or information on the next periodic inspection notification scheduled date is stored in the storage unit. Writing these pieces of information to the storage unit may be performed by, for example, a person who installed the system (or unit) or a person in charge of the equipment manufacturer who performed the periodic inspection. Also, when the equipment manufacturer delivers the unit to a user, the reference date information may be written in the storage unit. As a result, even in cases where the equipment manufacturer does not get involved in the installation of the unit since the unit has been transferred or sold among different users, initial reference date information can be stored in the storage unit.

The periodic inspection processing unit included in the integrated control unit collects the information stored in the date information storage unit in each unit constituting the system, for example, at a predetermined timing such as when the system is powered on, or periodically during power-on. The integrated control unit is equipped with a real-time clock to control the operation of each unit, and the periodic inspection processing unit utilizes this real-time clock to determine whether or not the periodic inspection notification date has reached for each unit. In cases where there is a unit that has reached the periodic inspection notification date, a periodic inspection notification request is sent to the unit. In the unit that received this periodic inspection notification request, the display processing unit displays the information prompting the implementation of the periodic inspection on the display unit to thereby raise the user's attention. Since the information prompting the implementation of the periodic inspection is displayed only on the display unit in the unit that requires the periodic inspection, the user can easily grasp the unit that the periodic inspection is required.

The modular-type analysis system according to the present invention is not particularly restricted in the method of analysis and measurement, but as a typical embodiment, it can be applied to a liquid chromatograph analysis system. That is, the modular-type analysis system according to the present invention may be a liquid chromatograph which includes, as a plurality of units, at least a liquid supply unit for supplying a mobile phase, an injector unit for injecting a sample liquid into a supplied mobile phase, a column oven unit for controlling a temperature of a column which separates components of the sample liquid, and a detector unit for detecting components in the eluate eluted from the column.

In this case, the integrated control unit may be configured such that the integrated control unit is provided in an independent unit different from each of the aforementioned units.

### Effects of the Invention

According to the modular-type analysis system of the present invention, regardless of the status of the system management by a user, when each unit constituting the system has reached a predetermined age of service, it is possible to automatically notify the user to perform the periodic inspection. Especially, even if the installation time are different for each unit constituting one system, or even if the age of service until the next periodic inspection is different, the notification can be made to the user exactly at the time at which the periodic inspection is to be required. As a result, high analytical performance can be maintained and safety of the system can be secured.

Further, each unit other than the integrated control unit does not require a real-time clock. In general, each unit is equipped with a microcomputer including a memory (non-volatile memory) usable as at least the date information storage unit. The reading and writing of the information into the date information storage unit and the function of the display processing unit in the modular-type analysis system according to the present invention can be realized by rewriting software which operates the microcomputer. Therefore, in order to realize the modular-type analysis system according to the present invention, the conventional hardware can be used as it is as each unit, and it is not necessary to provide a new unit.

Furthermore, in the modular-type analysis system according to the present invention, if the system is configured so as to include a unit in which the integrated control unit is provided, it is possible to notify the user of the periodic inspection without connecting a personal computer to the system. Therefore, even in a situation in which an environment for connecting the personal computer to the Internet network or the like is not in place, a notification of the periodic inspection can be assuredly performed.

### BRIEF DESCRIPTION OF THE DRAWINGS

FIG. 1 is an external front view of a main part of a liquid chromatograph (LC) system according to an embodiment of the present invention.

FIG. 2 is a flow path configuration diagram of the LC system of this embodiment.

FIG. 3 is a block configuration diagram of a control system of the LC system of the embodiment.

FIG. 4 is a schematic diagram showing sending and receiving signals between units and between constituent elements in the LC system of the embodiment.

### EMBODIMENTS FOR CARRYING OUT THE INVENTION

Hereinafter, an LC system which is one embodiment of a modular-type analysis system according to the present invention will be described in detail with reference to the attached drawings.

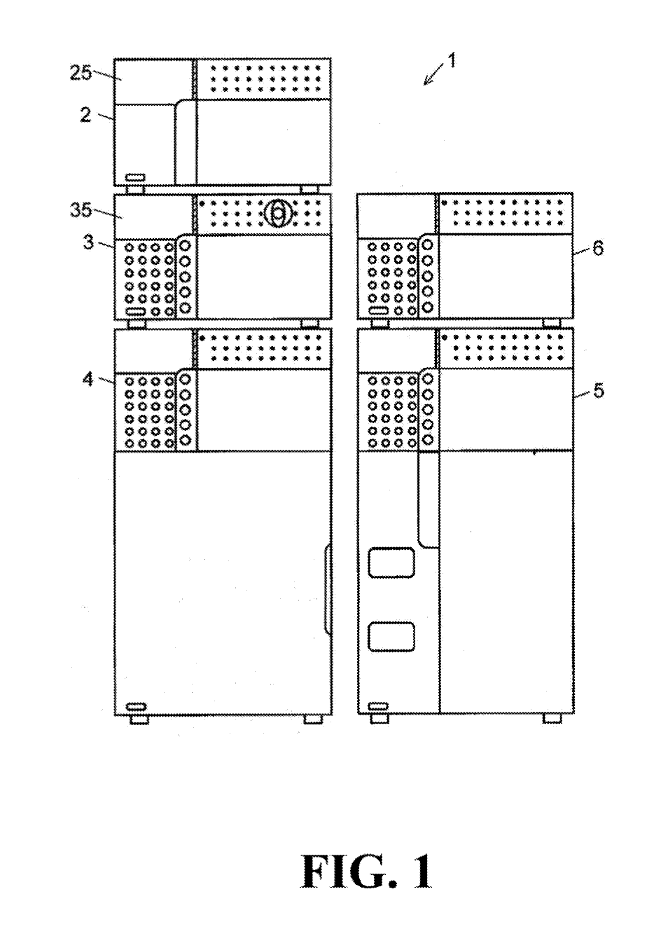

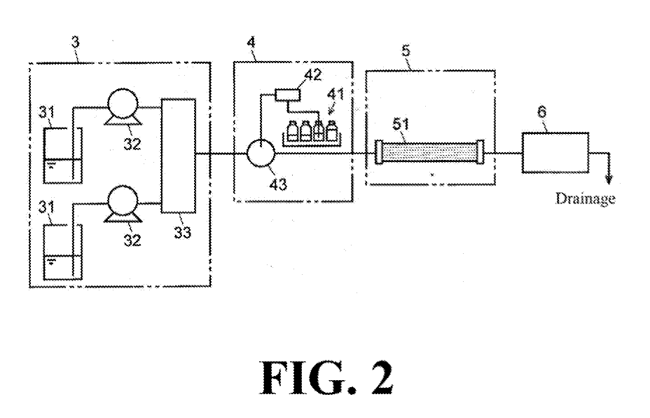

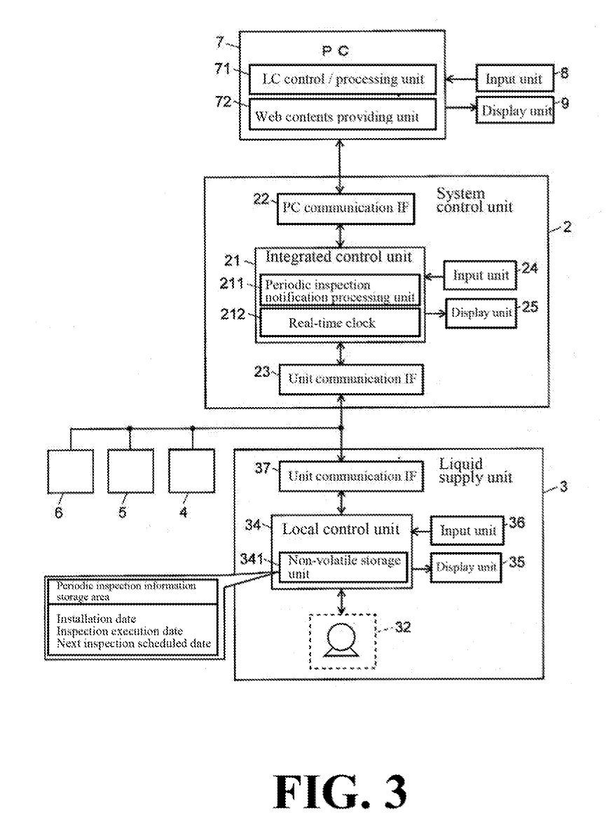

FIG. 1 is an external front view of an analysis main body of the LC system of this embodiment, FIG. 2 is a flow path configuration diagram of the LC system of this embodiment, and FIG. 3 is a block configuration diagram of a control system of the LC system of this embodiment.

The LC system of this embodiment includes an analysis main body 1 composed of a liquid supply unit 3, an autosampler unit 4, a column oven unit 5, a detector unit 6, and a system control unit 2, and a personal computer (PC) 7 for controlling the analysis main body 1 or processing data obtained at the analysis main body 1.

As shown in FIG. 2, the liquid supply unit 3 is equipped with a mobile phase container 31 in which a mobile phase is accommodated, a liquid supply pump 32 for sucking and sending the mobile phase from the mobile phase container 31, and a gradient mixer 33 for mixing a plurality of mobile phases. It can be conceived that a liquid supply unit includes more numbers of mobile phase containers 31 and liquid supply pumps 32 and a liquid supply unit includes one mobile phase container 31 and one liquid supply pump 32 and does not include a gradient mixer.

The autosampler unit 4 is equipped with sample plates 41 in which a plurality of vials each containing sample liquid are stored, a suction part 42 for sucking a certain amount of sample liquid from the selected one vial, and an injector 43 for injecting the sample liquid sucked by the suction part 42 and injecting the sample liquid into the mobile phase.

The column oven unit 5 includes a heater unit (not illustrated) or the like, and can control the temperature of the column 51 loaded therein.

The detector unit 6 includes a detector of any one of methods including, e.g., a photodiode array detector, an UV-visible absorption detector, a spectral fluorescence detector, or a differential refractive index detector.

As shown in FIG. 1, the system control unit 2, the liquid supply unit 3, the autosampler unit 4, the column oven unit 5, and the detector unit 6 are units each having an independent housing, but the width of the housing and the front design of the housing are unified, so that the visual sense of unity is ensured.

As shown in FIG. 3, an input unit 8 which is a keyboard or a pointing device, and a display unit 9 which is a monitor are connected to the PC 7. Software dedicated to the control and processing of the LC is installed in the PC 7. When the software is executed on the PC 7, the functional block of an LC control/processing unit 71 is embodied, so that settings of analysis parameters, control of the analysis operation based on the parameters, calculation processing of the data collected in the analysis main body 1, etc., are executed. Further, the functional block of a Web contents providing unit 72 is embodied by another software installed in the PC 7.

A system control unit 2 connected to the PC 7 via a network (for example, the Internet or an intranet) includes, in addition to an integrated control unit 21 for sending control signals to each unit 3 to 6, a PC communication interface (IF) 22 for mutual communication with the PC and a unit communication interface (IF) 23 for mutual communication with other units 3 to 6. The integrated control unit 21 includes, as functional blocks for performing characteristic processing which will be described later, a periodic inspection notification processing unit 211 and a real-time clock 212. An input unit 24 and a display unit 25 are further connected the integrated control unit 21. The liquid supply unit 3 includes, in addition to a local control unit 34 for operating a pump body of, e.g., a plunger pump or a gradient mixer, a unit communication interface (IF) 37 for communicating with the system control unit 2. The local control unit 34 to which an input unit 36 and a display unit 35 are connected includes a non-volatile storage unit 341.

Although not illustrated in FIG. 3, the autosampler unit 4, the column oven unit 5, and the detector unit 6 are each equipped with a local control unit and a unit communication interface in the same manner as in the liquid supply unit 3.

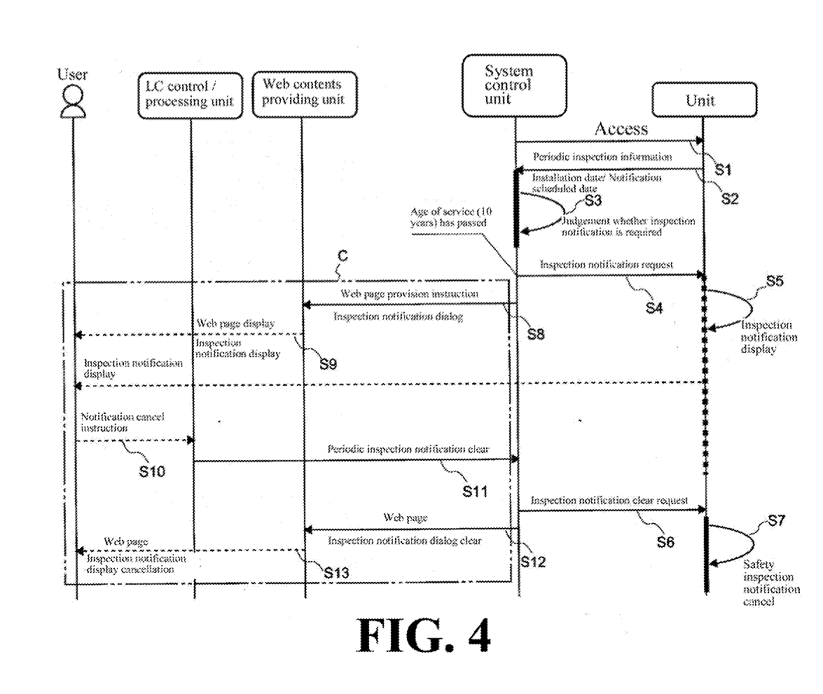

In the LC system of this embodiment, periodic inspection notification processing to a user is performed in the procedure shown in FIG. 4. FIG. 4 is a schematic diagram showing sending and receiving signals between units and between constituent elements.

The non-volatile storage unit 341 provided in the local control unit 34 of the liquid supply unit 3 is provided with a periodic inspection information storage area as shown in FIG. 3. It is configured such that, in the storage area, the new installation date, the inspection execution date, and the next inspection scheduled date of the unit 3 can be stored. For example, when a person in charge of the equipment manufacturer performed a new installation work, the person inputs the date by performing a predetermined operation by the input unit 36. With this, the input information is stored as the installation date in the periodic inspection information storage area of the non-volatile storage unit 341. Further, when a person in charge of the equipment manufacturer performed periodic inspection and maintenance, the person inputs the date by performing a predetermined operation by the input unit 36. With this, the input information is stored as the inspection date in the periodic inspection information storage area of the non-volatile storage unit 341. The same is applies to the units 4 to 6 other than the liquid supply unit 3.

The next inspection scheduled date is determined on the basis of the installation date or the inspection date according to the age of service specified for that unit. It is preferable that when the installation date or the inspection date is input, the next inspection scheduled date is automatically calculated based on the age of service from that time and written. Note that this next inspection scheduled date may be omitted.

Other than the installation date, at the stage when the equipment manufacturer ships the unit from the factory or the like or delivers the unit to a user, the information of the the shipping date or the like may be stored in the non-volatile storage unit 341, and the shipping date may be used instead of the installation date. As a result, even in cases where the person in charge of the equipment manufacturer does not perform the installation work and the user performs the installation work, the initial reference date information can be reliably written in the non-volatile storage unit 341.

In the system control unit 2, the periodic inspection notification processing unit 211 accesses each of the units 3 to 6 via the unit communication interface 23 at the time of turning on the power of the system or at the time of startup (for example, at the time of returning from the sleep state) (Step 51), and the date information stored in the periodic inspection information storage area of the non-volatile storage unit 341 of each of the units 3 to 6 is read out and collected (Step S2). After that, the periodic inspection notification processing unit 211 compares, when the next inspection scheduled date is recorded for each of the units 3 to 6, the recorded next inspection scheduled date with the current date information by the real-time clock 212, and compares, when the next inspection scheduled date is not recorded, the date obtained by adding the age of service at the time of the installation date or the inspection date with the current date information, to thereby determine whether or not a periodic inspection notification is necessary (Step S3). If the current date has not reached the next inspection date, the processing is terminated as it is.

For example, if the next inspection scheduled date collected from the liquid supply unit 3 has already passed the current date, it is judged that the periodic inspection notification of the unit 3 is necessary and a periodic inspection notification request is sent to the liquid supply unit 3 (Step S4). The local control unit 34 of the liquid supply unit 3 which received this periodic inspection notification request outputs a prescribed display prompting the periodic inspection to the display unit 35 (Step S5). This display may be canceled by the operation of the input unit 36 provided in the liquid supply unit 3 or may be canceled only by a predetermined operation in the input unit 24 of the system control unit 2. For example, when the cancel operation is performed with the input unit 24 of the system control unit 2, the periodic inspection notification processing unit 211 sends a request to the liquid supply unit 3 to clear the periodic inspection notification (Step S6), and the local control unit 34 of the liquid supply unit 3 which received the request cancels the display prompting the periodic inspection (Step S7).

When the user sees the aforementioned display, the user requests the equipment manufacturer to perform the periodic inspection of, for example, the corresponding liquid supply unit 3. A service personnel of the equipment manufacturer visits, for example, the site of the user and performs predetermined inspection and maintenance of the liquid supply unit 3 which requires the periodic inspection. When it is finished, the service personnel performs a predetermined operation with the input unit 36 to write the periodic inspection execution date in the non-volatile storage unit 341 and rewrites the next periodic inspection scheduled date.

The above description is directed to the periodic inspection notification processing completed only in the analysis main body 1, that is, only in the system control unit 2 and the other units 3 to 6. As shown in FIG. 3, however, in cases where the PC 7 is connected to the analysis main body 1 via the network, the periodic inspection notification processing can be performed in the PC 7 as will be described below. In FIG. 4, the periodic inspection notification processing by the PC 7 is shown by the box-shaped two-dot chain line indicated by C.

That is, when the system control unit 2 recognizes that a periodic inspection notification is necessary for a certain unit, the system control unit 2 sends information identifying the unit which requires periodic inspection and issues a request to display the periodic inspection notification dialog to the Web contents providing unit 72 of the PC 7 (Step S8). In response to the request, the Web contents providing unit 72 prepares a Web page for a periodic inspection notification created and stored in advance. This Web page can be confirmed on the screen of the display unit 9 by a Web browser standardly provided on the PC 7 (Step S9), and the user recognizes that periodic inspection of a specific unit is necessary by checking the Web page on the screen.

When the user performs a predetermined operation with the input unit 8 of the PC 7 and instructs cancellation of the periodic inspection notification (Step S10), the LC control/processing unit 71 which received the instruction instructs the system control unit 2 of the analysis main body 1 to clear the periodic inspection notification (Step S11). In response to this, the system control unit 2 instructs the Web contents providing unit 72 of the PC 7 to clear the periodic inspection notification dialog (Step S12). As a result, the system control unit 2 instructs the Web contents providing unit 72 to cancel the display of the check notification dialog, and the Web contents providing unit 72 closes the Web page for the periodic inspection notification displayed on the screen of the display unit 9 (Step S13).

In this manner, in the LC system of this embodiment, a periodic inspection notification of a unit which requires periodic inspection can be performed even on the PC 7 which is responsible for control and data processing. In this case, since the periodic inspection notification is provided on a Web page, in cases where another user terminal is connected to the network, it is possible to receive the periodic inspection notification using the Web browser installed in the user terminal.

In the aforementioned embodiment, the function of the integrated control unit 21 is provided in an independent unit named system control unit 2, but the function of the integrated control unit 21 may be provided in one of the other units 3 to 6.

Although the aforementioned embodiment is an example in which the present invention is applied to an LC system, the modular-type analysis system according to the present invention can also be applied to various analysis devices other than an LC, such as gas chromatograph, mass spectrometer, spectrometer, scanning probe microscope, and the like.

It should be noted that the aforementioned embodiment is merely an example of the present invention, and even if appropriate changes and additions are made within the scope of the gist of the present invention, it is encompassed within the claim of the present application.

### DESCRIPTION OF REFERENCE SYMBOLS

1: analysis main body
2: system control unit
21: integrated control unit
211: periodic inspection notification processing unit
212: real-time clock
23: unit communication interface
24, 36: input unit
25, 34: display unit
3: liquid supply unit
31: mobile phase container
32: liquid supply pump
33: gradient mixer
34: local control unit
341: non-volatile storage unit
4: autosampler unit
41: sample plate
42: suction part
43: injector
5: column oven unit
51: column
6: detector unit
7: personal computer (PC)
71: LC control and processing unit
72: Web contents providing unit
8: input unit
9: display unit

1. A modular-type analysis system constituting a system for performing an analysis by combining a plurality of units each having an independent housing, the system including an integrated control unit for controlling operations of the plurality of units so as to perform the analysis, and the integrated control unit being provided independently in an independent unit different from the plurality of units or provided in one of the plurality of units, the modular-type analysis comprising:
a) a date information storage unit provided in each of the plurality of units to store at least one of reference date information which becomes a reference for counting year and month at which periodic inspection of each of the plurality of units is to be carried out and information on a next periodic inspection notification scheduled date;
b) a periodic inspection processing unit included in the integrated control unit and configured to collect information stored in the date information storage unit in each unit, judge whether or not a periodic inspection notification date has reached for each unit based on the collected information, and send, when there is a unit that has reached the periodic inspection notification date, a periodic inspection notification request to the unit; and
c) a display processing unit provided in each of the plurality of units and configured to display information prompting implementation of periodic inspection in response to the periodic inspection notification request from the periodic inspection processing unit.

2. The modular-type analysis system as recited in claim 1,
wherein the modular-type analysis system is a liquid chromatograph which includes, as the plurality of units, at least a liquid supply unit for supplying a mobile phase, an injector unit for injecting sample liquid into a supplied mobile phase, a column oven unit for controlling a temperature of a column which separates components of the sample liquid, and a detector unit for detecting components in an eluate eluted from the column.
